(19) United States
(12) Patent Application Publication
(10) Pub. No.: US 2010/0169802 A1
(43) Pub. Date: Jul. 1, 2010

(54) Methods and Systems for Storing, Processing and Managing User Click-Stream Data

(76) Inventors: Seth Goldstein, New York, NY (US); Goldstein Jonas, Brooklyn, NY (US)

Correspondence Address: CHRISTINE JOHNSON ESQ., 151 Trenton Rd., Fairless Hills, PA, 19030, US

(21) Appl. No.: 12/514,068

(22) PCT Filed: Nov. 8, 2007
(86) PCT No.: PCT/US07/84181

§ 371 Date: Mar. 19, 2010

Related U.S. Application Data
(60) Provisional application No. 60/857,995, filed on Nov. 8, 2006.

(51) Int. Cl. G06F 3/048; G06F 3/01; G06F 17/30

(52) U.S. Cl. 715/760; 707/802; 715/856; 707/E17.044

(57) ABSTRACT

Methods and systems for enabling users to capture, store, and analyze attention data, particularly Internet website click-stream data. Captured, stored attention data may be used by the individual, or, through permissions, the data may be made available to other private and commercial users. The invention thus enables users to recognize both personal and potential commercial value from an electronic record of their attention. The invention includes not only the basic capture and store of attention data, but also the ability to process attention data in a variety of different manners.

### CROSS REFERENCE TO RELATED APPLICATIONS

This application claims benefit of U.S. provisional application Ser. No. 60/857,995 filed in the USPTO on Nov. 8, 2006.

### FIELD OF THE INVENTION

The present invention relates generally to methods and systems for storing and managing data and more particularly to methods and systems for storing, processing and managing user click-stream activity.

### BACKGROUND OF THE INVENTION

With the advent of electronic networks such as the Internet, it is possible today for users to access huge quantities of information, simply by sitting at a computer and selecting electronic links to information files. This is also referred to as ‘browsing’ the Internet by clicking on information hyperlinks. The activity can have a purpose ranging from recreational, to research/educational, to commercial.

The list of pages or information reviewed, also known as the user's ‘attention’ or ‘click-stream,’ can have significant value to advertisers, vendors and others. Knowledge of where a user has focused his or her attention can provide significant information, including, for example: political leanings, commercial interests and intentions, age and other demographics, sexual interests and much other information.

Click-stream information is of particular interest to commercial users, both for the purpose of optimizing their own web sites and for facilitating commercial transactions.

However, present techniques for recording and analyzing a user's click-stream data are typically carried out without the knowledge, and often without the consent of the user. The present inventors have recognized that the users themselves have significant interests in their own click-stream information, the interests including commercial as well as privacy interests. The present inventors have also recognized that, heretofore, no good methods or systems were available for enabling users to collect, store, process and manage their own click-stream information.

### SUMMARY OF THE INVENTION

The present invention provides users with the ability to collect, store, process and otherwise manage their personal click-stream information. The present invention also provides users the ability to selectively share their click-stream information with other users. In different embodiments, the present invention may provide users the ability to utilize their own click-stream data for different types of commercial return.

### DESCRIPTION OF THE DRAWING FIGURES

These and other objects, features and advantages of the invention will be apparent from a consideration of the following Detailed Description Of The Invention considered in conjunction with the drawing Figures, in which:

FIG. 1 is a system block diagram of a network configuration suitable for implementing embodiments of the invention.

FIG. 2 is a block diagram of a user system including a recorder according to an embodiment of the invention.

FIG. 3 illustrates an example interactive menu enabling a user to deploy a recorder of the invention.

FIG. 4 is an example interactive web page enabling a user to deploy a blacklist feature provided by embodiments of the invention.

FIG. 5 is an example graphical display of click information for a plurality of users in accordance with the embodiment of the invention illustrated in FIG. 7.

FIG. 6 is an example of a display screen providing a graphical representation of click information.

FIG. 7 is a block diagram of a system for sharing click information according to an embodiment of the invention.

FIG. 8 is a flowchart depicting steps of a method for sharing click information according to an embodiment of the invention.

FIG. 9 is a flowchart illustrating steps of a method for analyzing click information according to an embodiment of the invention.

### DETAILED DESCRIPTION OF THE INVENTION

In accordance with the present invention, there are provided herein methods and systems that enable users to record or store, process and share their click-stream data. While the invention is shown and described with respect to Internet browser history data, it is not thus limited. The invention has application to recorded attention in other areas, for example books read, movies watched, television programs viewed, desktop applications used and numerous other areas as will now be apparent to the reader.

### DEFINITIONS

As used herein, the term “click” refers to a press of a key on a user interface device, for example on a computer mouse button. The term click also refers to a signal generated by pressing such a key or button. For example for computer user to execute a certain software function, he or she typically moves a cursor to a certain location on a screen and then clicks a mouse button. An example of this is a user clicking on an interactive area, or icon, on a screen of a display device. Computer users click on hyperlinks to navigate from document to document. User interfaces, for example graphical user interfaces, are sometimes described as “point-and-click” interfaces indicating requiring that a user may simply point to indicate their wishes and click. Thus clicks are sources of information about users' intentions, attention, choices and wishes. For purposes of this specification the term “click” also refers to information about a user interface activated by a click.

As used herein, the term click also refers to “click-stream”, that is, data related to sequences of successively viewed web pages. Click-stream data includes, for example, browser history, browser redirects, displayed frames, etc. as well as ancillary ‘atomic’ data such as exact times, cookies, response data, sub-page data, meta-data and the like. Further exemplary click-stream data includes Universal Resource Locator data, or hyperlinks. Such data may include, for example: originating webpage information, terminating webpage information, times, dates, an indication of an activity such as a search, sub-page data and other information well known to the reader. Exemplary click-stream data may take the appearance of, for example:

http://www.google.com/search?client=safari&rls=en&q=attentiontrust&ie=UTF-8&oe=UTF-8
https://vaults.root.net/people/jbrandt/
http://weather.yahoo.com/forecast/USCT0185_f.html

As used herein, the term “attention” refers generally to readiness to respond to stimuli. In the context of some embodiments of the invention “attention” refers to an individual computer user's readiness to respond to stimuli. According to some embodiments of the invention a computer user's attention is indicated directly by, or inferred from, clicks initiated by the user. Attention data is ascertained by monitoring and/or recording clicks, click-streams, various operations of a user and the operating states of a user's computer.

As used herein the term “attention-data” and “attention-stream” are used to refer to detectable or inferential indications that a computer user pays attention to something or that a computer user ignores something. These indications are detected by a system configured in accordance with embodiments of the invention. Data is generated based on these detected indications. This data is organized in accordance with the invention described herein as relating to “attention”. Therefore, this data is referred to herein as attention data. Attention data is valuable in that it reflects a user's interests, activities and values. According to some embodiments of the invention attention data is organized and deployed to serve as a proxy for a user's attention.

An attention-stream comprises a click stream according to some embodiments of the invention. However, a click-stream is but one example of a variety of possible indications of a user's attention. Other examples include web pages and web page content displayed to a user, detectable machine state changes associated with the user's computer, executable programs opened, closed and running on the user's computer and information provided directly by the user, to name but a few examples of indications of attention.

The term “machine state change” refers to any response of a computer or processor to a click, or user initiated action. External input includes input by keyboard, mouse, video camera, microphone, infra-red device, thermal detecting devices, switches, or any sensor providing a computer detectable signal at the sensor output.

As used herein the term “attention-stream” refers to a sequence of detectable indications of a user's attention over a time interval. For example, an attention stream comprises a click-stream. In another example, an attention stream comprises a series of detected visited web pages according to embodiments of the invention. An attention stream also refers to a sequence of detectable machine states, or state changes, indicating computer program execution, process states and other detectable processor and operating system changes resulting from a user's computer related activity. According to some embodiments of the invention, inferences are drawn about the user's attention over a time interval by analyzing the detected attention-stream information.

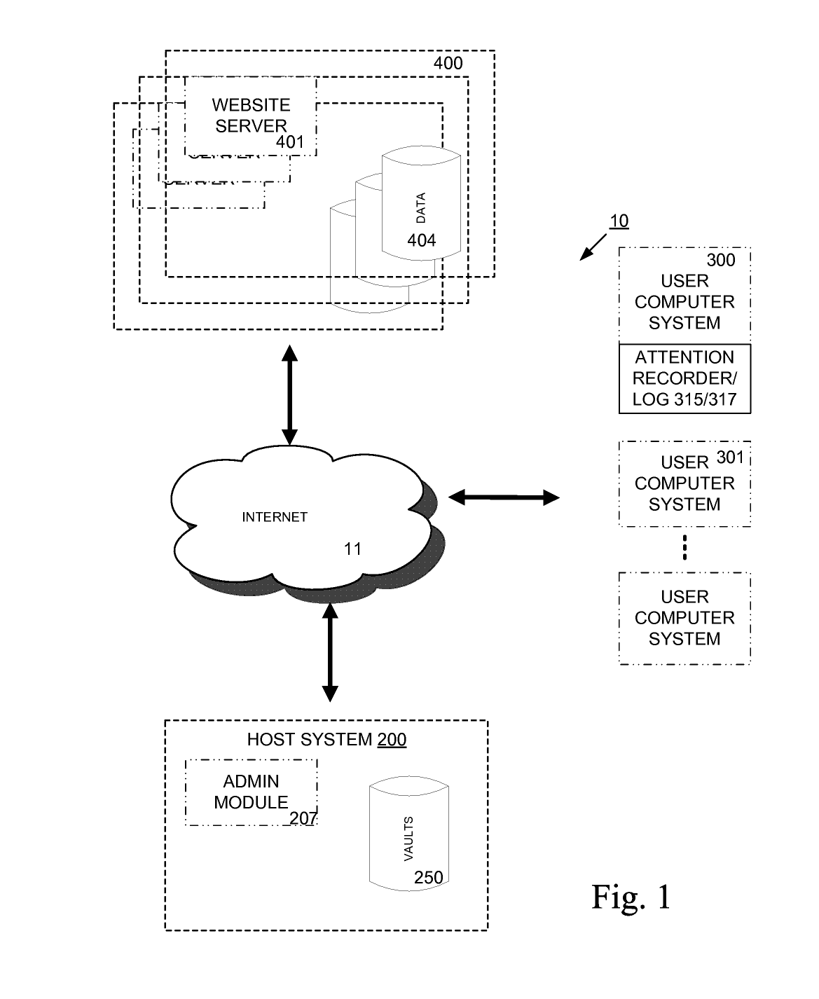

### FIG. 1 Network Configuration

FIG. 1 illustrates a network 10 suitable for implementing embodiments of the invention. Network 10 comprises at least one host system 200, at least one website system 400 and at least one user computer system, for example user systems 300, 301 and 305. For purposes of discussion three user computer systems are shown in FIG. 1. However, the invention is not limited to any particular number of host, website or user systems. The user computer systems, websites and host system are configured for communication with each other via the World Wide Web 11 (also referred to herein as the Internet). Computer users employ user computers 300 to browse the Internet 11 through conventional interfaces such as computers, cellular telephones, personal digital assistants and other known Internet interfaces with browser capability.

### Host System 200

In some respects, host system 200 comprises a conventional server including processors and storage means, for example databases and memory. However, in contrast to conventional host systems, host system 200 is configured to enable users to access and log into a click-stream recording service for recording click-stream data captured by a recording tool provided by embodiments of the invention.

### Web Sites

Websites 400 typically include a server 401 and stored data 404. Exemplary websites include those provided by Internet businesses, services, individuals, etc. both private and commercial. When a user visits a website and clicks on a piece of content while at the website, the click is interpreted as a request for information from the user and is sent to the website over the network 11. The website then responds by sending the requested content to the user at user computer system 300. Thus a user generates a click-stream comprising these clicks during each website visit. According to embodiments of the invention a click-stream generated by an individual user during that individual user's visit to a web site represents at least one component of that individual user's attention during the time period in which the click-stream was generated.

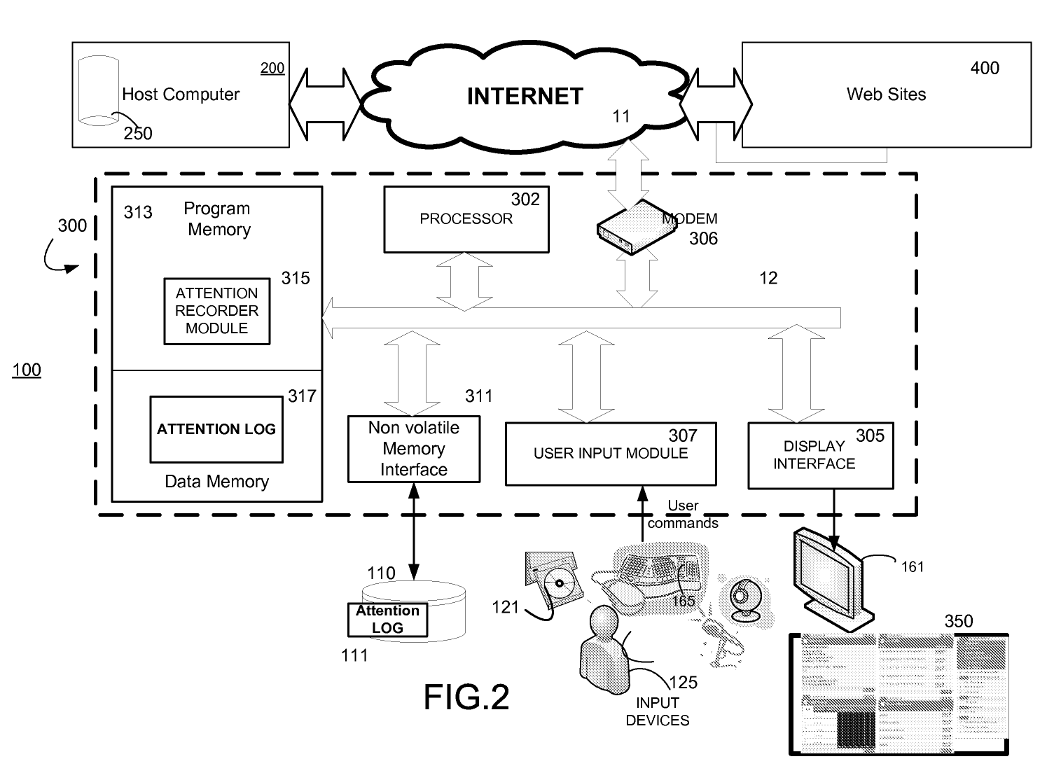

### FIG. 2 User Computer System

FIG. 2 is a block diagram illustrating further details of user system 300 illustrated in FIG. 1. User system 300 comprises, for example, a personal computer coupled to a display device 161 and at least one user input device. User input devices suitable for implementing features of the invention include, but are not limited to keyboard 125, mouse123, video camera 127, and microphone 129. A user input module 307 receives indications in the form of signals from user input devices as user 125 operates the devices. For example, when browsing the Internet user 125 views interactive web pages from web sites 400 on display device 161. User 125 “clicks” a mouse or keyboard key to “activate” icons, text or other widgets displayed on display device 161. In that manner user 125 interacts with web site 400 by signals generated by the user's clicks. The clicks are detected and interpreted by computer system 300 and are provided to web site 400 via a modem 306 configured for communication on a wide area network, for example, the Internet 11. Likewise web site 400 transmits interactive web pages to user system 300 for display on display 161 via display interface 305

A processor 302 controls operation of components of system 300 to effect transfer of data and other information over a system interconnecting bus 12. Processor 302 communicates with program memory 313 to execute program commands stored in memory 313. Computer system 300 further includes a data memory 317 and non volatile memory 311. Program memory 313 stores programs, including application programs, for execution by processor 302. Data memory 317 stores data associated with programs in program memory 313. Non volatile memory 110 communicates with system 300 via non volatile memory interface 311 to store programs data and other information.

Communications between host system 200 and user computer system 300 comprises signals, for example electronic, optical, radio frequency, or other signals. User computer 300 converts the signals to a human understandable form when sending a communication to the user and converts input from a human to appropriate electronic, optical, radio frequency, or other signals to be used by computer 300 host system 200 or web sites 400.

### Attention Recorder Module

According to an embodiment of the invention host computer 200 is configured to instantiate an attention recorder module 315 in a user system 300. In one embodiment of the invention this operation is initiated at the request of user 125. Attention recorder module 315 installs an attention log 317 and cooperates with the installed attention log to store attention data of user 125. To install an attention recorder module 315 a user 125 accesses host system 200, for example via the Internet, and requests a recorder. In response to the request by user 125 host system 200 provides an attention recorder program module comprising a “plug in” to a browser of user computer system 300. Browser plug-ins are executable programs that extend, or add-on to the functionality of a web browser. In alternative embodiments of the invention, an attention recorder program module comprises a web browser itself. In other embodiments the attention recorder program module is provided as a browser toolbar.

An embodiment of the invention implements attention recorder module 315 as a browser plug in configured in accordance with embodiments of the invention and stored in a portion of a program memory 313 of user computer system 300.

Attention recorder program module 315 responds to signals corresponding to clicks as user 125 operates computer system 300, for example to browse the internet. In response to user generated clicks program module 315 stores clicks and information associated with the stored clicks. In one embodiment the stored clicks comprise click-streams. Information associated with clicks includes for example raw web page requests (referred to as hits) made by user 125 while browsing the Internet 11 and information associated with these hits such as timestamp, IP address, URL, status, number of transferred bytes, referrer, user agent, and, sometimes, cookie data. Click-stream recorder 315 operates to capture and store this individual click-stream data for future use of individual user 125 in the individual user's attention log file 317.

In that sense attention recorder module 315 comprises a click recorder or click-stream recorder. In other embodiments of the invention discussed herein-below, clicks are but one of a plurality of indicators of attention of user 125. In those embodiments attention recorder module 315 is configured to detect and store a plurality of indicators of attention, including, but not limited to clicks of user 125. According to some embodiments of the invention attention recorder module 315 is configured to detect other indicators of attention of user 125.

Other indicators of attention include, for example, any action of user 125 taken with respect to a peripheral device such as camera 161, microphone 167, CD, DVD or other disk input device 165, personal digital assistant (PDA) 171, display 121, touchpad (not shown) trackball (not shown), gaming console (not shown) or any other devices communicating with a computer system 300 of user 125 and operable by user 125 to interact with system 300. According to other embodiments of the invention attention information can be entered into attention log directly by user 125. For example user 125 may record books read, television programs watched, and other personal diary and log information relating to user 125 or the interests or activities of user 125.

Attention recording instructions comprising attention recorder module 315 are executed by processor 302 to control the components of user computer system 300, attention recorder module 315 and attention log 317 such that attention indicators are recorded and stored in attention log 317.

In other embodiments of the invention, in addition to the attention indicators described above, attention recorder module 315 is configured to infer attention of user 125 by detecting and interpreting operating states and state changes of computer system 300 of user 125. For example, attention of user 125 is inferred from recording user interaction with a running application program, for example a word processing program, a video editing program, a spreadsheet, and a database, to name but a few types of application programs with which a user 125 is enabled to interact using user computer system 300.

In some embodiments of the invention inattention of user 125 comprises an indication of attention. Inattention comprises periods of time wherein there is no activity by user 125, either with respect to a given application program or device, or with respect to computer system 300 overall, or with respect to any portion thereof. In these example embodiments, attention recorder module 315 is configured to detect periods of inattention and store data representing the periods of inattention in attention log 317.

A user interface module 307 receives at least one indication of attention, for example, clicks generated by computer user 125 during the user's operation of user input devices coupled to computer 300. User interface module 307 provides clicks to be transported via bus 12 for storage in attention log 317 under control of processor 302 in accordance with instructions provided by attention recorder module 315.

According to one embodiment of the invention a wide variety of types of clicks generated by user 125 are stored in attention log 317. For example a user employing a keyboard to enter a search term into a web browser generates clicks. The search term itself, may relate for example to the user's search for information about a new appliance. Nonetheless the clicks generated by the user in entering the search term are still provided to attention recorder 100. At the same time the clicks are processed by the user's computer in a conventional manner to allow the user to initiate a search for the new appliance. In addition some embodiments of attention recorder module 315 operate to store the search term in attention log 317.

Clicks generated by user 125 relating to control of attention recorder module 100 are provided to processor 102. Processor 102 operates in accordance with instructions provided by attention recorder module 315 to carry out the user's commands. For example, user 125 initiates display of data stored in click log 317 by providing a display command to click recorder 100. In response to the command, processor 102 generates a control signal. The control signal causes click log 317 and display interface 125 to cooperate. Together they provide a representation of the data stored in click log 317 for display on a display device 121 of the user's computer system 300.

In one embodiment of the invention attention recorder module 315 comprises a browser extension, for example a Firefox® Web browser extension. System 200 enables user 125 to install attention recorder module 315 as an extension to the user's browser. In addition embodiments of the invention equip the user's browser a toolkit comprising utilities enabling user 125 to manage attention recorder module 315 and the information stored in attention log 317.

For each web page visited by user 125, attention recorder module 315 will operate to save “clicks” comprising click related information. Examples of click related information comprising clicks in the context of an embodiment of the invention include, but are not limited to, the visited web page's URL, the web page's title, the Hypertext Transfer Protocol (HTTP) response code, and whether that web page read or wrote any cookies. In some embodiments of the invention, the contents of the cookie are recorded as clicks. In other embodiments of the invention the contents of cookies are not recorded. In some embodiments of the invention the control program will execute to record a date and time stamp in log 317 corresponding to clicks.

Some embodiments of attention recorder module 315 cooperate with computer system 300 to provide an interactive display. In that case, display interface 125 receives click information provided by attention log 317 and provides the information for display on display device 161 of a computer system 300 of user 125.

### Attention Log 317

Attention log 317 records user selected information relating to attention as described above. User interaction with a graphical user interface (GUI) provides one of a plurality of indications of user attention. A graphical user interface or GUI is a type of user interface which allows a computer user to interact with a computer and computer-controlled devices which employ graphical icons, visual indicators or special graphical elements along with text, labels or text navigation to represent the information and actions available to a user. The actions are typically performed through direct manipulation of the graphical elements. According to embodiments of the invention, when a click is recorded in attention log 317, information about the graphical element, text, label, URL or intended action corresponding to the click is also recorded.

In one embodiment click log 317 stores clicks as user 125 browses the Internet. In one embodiment of the invention attention recorder module 315 is configured to enable user 125 to store the user's individual browsing history and the user's individually generated click-stream information. In one embodiment of the invention browsing history and click-stream information comprise the user's “attention data”. In one embodiment of the invention the click information, browser history and other information related to user actions while browsing the internet are stored in click log 317, for example as a .txt file.

In one embodiment of the invention click log 317 comprises a browser profile folder, for example, a Firefox™ profile folder. In one example embodiment of the invention click log 317 comprises an Extensible Markup Language (XML) file. It will be understood, the location of click log 317 will vary depending on the operating system of user computer system 300.

In one embodiment of the invention click log 317 is implemented on a local hard disk of computer system 300. In one embodiment of the invention click log 317 comprises a file named, for example, in accordance with the following general format: attention_log.txt. In one embodiment of the invention click log 317 is stored in a profile directory, for example a Firefox profile directory of computer system 300. In an example embodiment based upon Windows XP click log 315 is located in accordance with the following example.
1) C:\Documents and Settings\[username]\Application Data\Mozilla\Firefox\Profiles\[random chars].default\attention_log.txt

In one embodiment of the invention the data stored in click log 317 comprises clicks of user 125 and is stored in XML format. Embodiments of attention recorder module 315 enable user 125 to provide a user specified location and filename comprising click log 317.

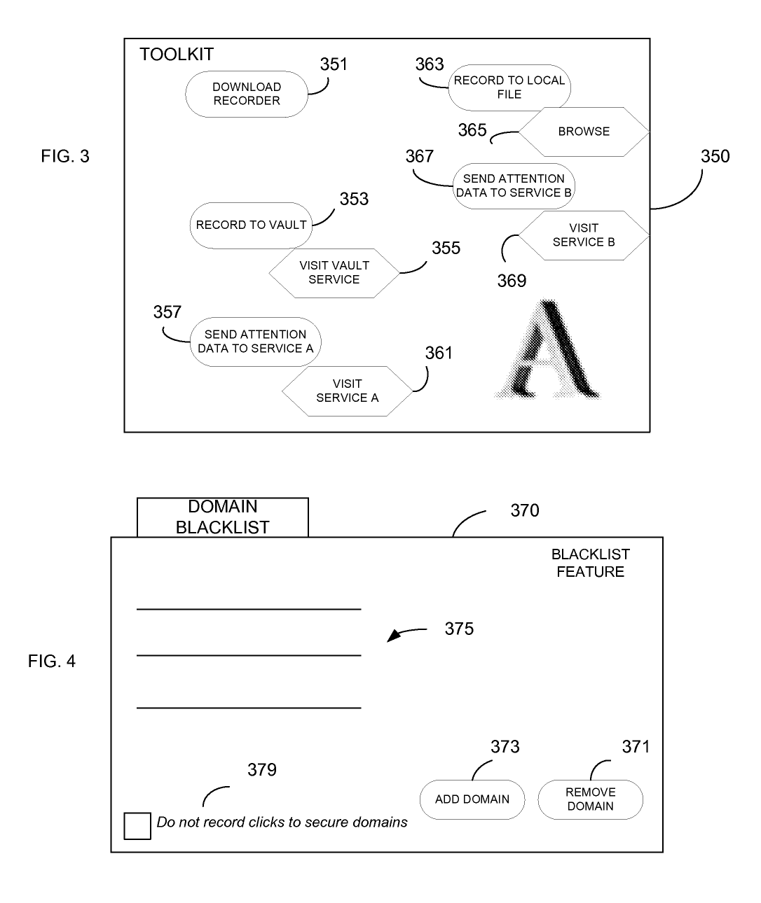

### FIGS. 3 & 4 Graphical User Interfaces

FIG. 3 illustrates an example interactive web 350 provided by host system 200 to user computer 300. Interactive web page 350 includes example interactive areas 351-369. Each interactive area provides a graphical user interface to host system 200. When activated by a user click an interactive area initiates operation of a functional unit of host system 200. Function units of host system 200 according to an embodiment of the invention include, but are not limited to: toolkits, for example for accessing attention related services 702, attention recorders to be provided for user system 300, providing an attention recorder hosted by host 200, providing a vault for storage of attention data and adding new attention services to host system 200.

### Send Attention Data to a Service

Interactive area 367 enables a user to provide his or her recorded attention-stream to a third party system, for example, a service system. To implement this option when selected by a user, system 200 sets three cookies during the initial download of the user's attention recorder. The cookies indicate which Approved Services a user has selected for initial use. When the installation of the user's recorder in system 300 is complete and the user's browser is restarted, the installed attention recorder reads the cookies and configures itself to send, or “feed' the user's recorded attention information to the user's initially selected services.

Recorder 315 of system 300 checks the attention-stream feed periodically, for example once every 24 hours. According to one embodiment of the invention the attention-stream feed includes a Service ID number which uniquely identifies the corresponding selected service. In that manner, system 200 provides recorders configured to enable a service to change its name or URL without affecting existing recorder feeds. One embodiment of the invention provides a feed formatted in accordance with an RSS 1.0 standard. Other embodiments of the invention are anticipated to employ an RSS 2.0 feed format. In one embodiment of the invention a feed includes a URL to which attention-streams are sent.

In one example embodiment of the invention recorder 315 of system 300 sends click-streams to all user selected services. The attention data is sent in accordance with a “REST” protocol, using an HTTP POST operation called via an XML HTTP Request call from recorder 315. In one embodiment the attention data is sent as a valid XML document as follows:

<attention
xmlns=“http://attentiontrust.org/attention/ns#”

version=“0.11”
recorderGUID=“{7118cc65-ee56-4af0-b5fc-37205e1bc61e}”
recorderVersion=“0.13”>

<httpTransactions>

<httpTransaction>

<title>Home | AttentionTrust.org</title>
<url>http://www.google.com/search?q=attention</url>
<cookie>1</cookie>
<setCookie>0</setCookie>
<responseCode>200</responseCode>
<method>GET</method>
<date>Tue, 04 Oct2005 15:07:16 GMT</date>

</httpTransaction>

</httpTransactions>

</attention>

The fields are defined as follows: url: The URL loaded by the browser; cookie: 1 (true) or 0 (false) indicating if a cookie was sent from the browser to the server; setCookie: 1 (true) or 0 (false) indicating if a cookie was set by the server; responseCode: The HTTP response code of the server. Common values are 200 (success), 301 (redirect), 404 (not found); method: The method by which the browser requested the page. Typically GET, POST, or PUT; title: The title of the retrieved page, if any, as specified in the page's<title> tag; date: The date+time that the browser requested the page, in Unicode Transformation Format (UTF) format.

Embodiments of attention recorder module 315 provide user operable controls, or “tools” to block certain clicks from being recorded to click log 317. For example, embodiments of the invention allow user 125 to “black list” user selected domains. By adding a domain to a black list no activity on that domain will be recorded by attention recorder module 315. Other embodiments of the invention enable a user to add a domain to a blacklist by providing a user operable control, for example, a mouse right-click, while the user visits a web page. When visiting the web page, the user initiates a right click and is provided with an option ‘Do not record visits to this site’. Selecting the option prevents recording visits to that site by attention recorder 315.

FIG. 4 illustrates a feature of one embodiment of the invention providing a blacklist tool 370. Blacklist tool 370 enables a user to select websites for which clicks will not be recorded when the user visits the web site. In one embodiment of the invention, browser plug-in is configured to inform a user when he or she is visiting the site of a provider pre-approved by host system 200. In one embodiment of the invention a list of pre-approved host sites is maintained by administration module 207 of host system 200. In one embodiment of the invention user 125 is enabled to add or delete Approved Services at any time after downloading the recorder 315 by opening the user's browser and going to Tools>Attention Recorder Options>Approved Services.

In one embodiment of the invention the list of pre-approved host sites is restricted to comprise only host sites that have provided an indication to host system 200 that the host site is operated in accordance with criteria stored by host system 200. For example, criteria related to property, economy, mobility, and transparency are stored by host system 200.

Accordingly, host system 200 is configured to restrict the list of pre-approved host sites to those sites operated in a manner that enables users to retain control over their personal information. In one embodiment of the invention, each host site comprising a pre-approved list provides text for display to users, clearly stating how a user's information is used by the host site, and allowing a user to withdraw the user's information if the user so desires.

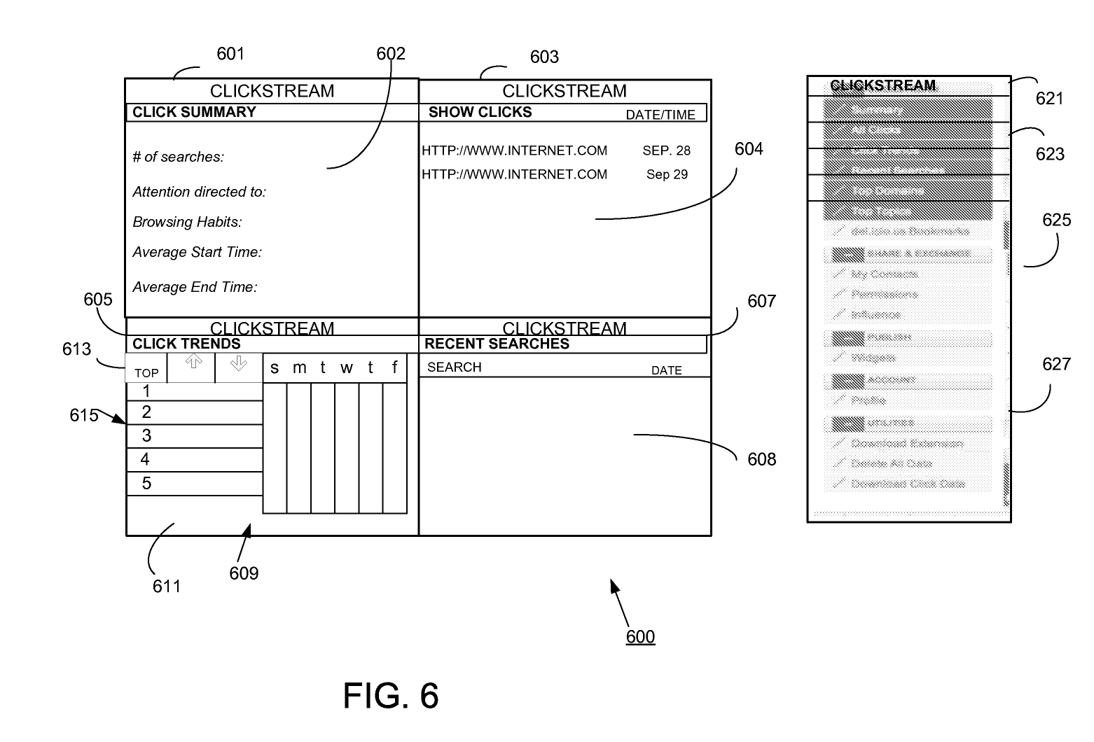

### FIG. 6 Graphical User Interface

FIG. 6 illustrates an example of a graphical user interface (GUI) 600 between a user and the user's attention-stream information. For example, GUI 600 provides a graphical illustration of the contents of log 317 (illustrated in FIG. 2). According to embodiments of the invention attention recorder module 315 implements GUI 600 for presentation on display unit 161. In one embodiment of the invention the user's attention-stream is also accessible for display on display unit 161 through a user's vault by accessing the contents of the vault via host system 200.

Graphical user interface 600 is provided, for example as a display screen 600 on display device 161 of user system 300. Embodiments of the invention display the information in one of several user-selectable formats. For example display screen 600 comprises display screen portions 602, 604, 611 and 608. Each display screen portion provides a graphical representation of the user's attention data. For example display screen portion 602 provides a click summary including for example, a number of searches performed by user 125, an indication of website destinations user 125 has paid attention to, an indication of the browsing habits of user 125, an average search start time and an average search end time.

According to various embodiments of the invention other information is displayed on portions of display screen 602. The following are but a few examples of information provided by embodiments of the invention: a summary of recent & historical browsing statistics showing start-times, end-times, search count, primary topic of interest and primary domain destination; an enumeration of recent searches by the major search engines (“Recent Searches”), an individual user's most common destination domains (“Top Domains”), an individual user's most common topics of attention (“Top Topics”); a historical stream of an individual user's Attention Click-stream events logged to the attention log 317 (“All Clicks”); a graphical representation (“ClickTrends”) of an individual user's Attention Click-streams showing them in a visual calendar layout.

Other information selectable for display on portions of display screen 600 include data collected from user searches, the percentage of attention paid by other computer users to click-stream data by topic, the percentage of attention paid by other users to click-stream data by domain and a list of all clicks of user 125 by date and time.

According to example embodiments of the invention click information comprises click-stream data organized to enable user 125 to visualize his or her individual internet usage trends. Example usage trends graphically represented on display 121 include, but are not limited to: domains with increasing clicks over time ('gainers'); domains with decreasing clicks over time; most visited domains; time spent by user 125 browsing the Internet in a user selectable time period (for example, each day, week, month, or other user selectable time period), and a histogram illustrating concentration of clicks e.g. how many sites have ‘few’ visits vs. how many sites have ‘many’ visits.

Display screen portion 627 implements a toolkit in accordance with an embodiment of the invention. Toolkit 627 comprises interactive areas, icons, or selectable text comprising functions associated with user operation of attention recorder module 315. For example, an icon 627 is operable by user 125 to initiate and terminate recording by attention recorder module 315. In one embodiment a green icon indicates recorder module 315 is recording and a red icon indicates recorder 315 is stopped. In one embodiment of the invention the icon is clickable to start or stop recording.

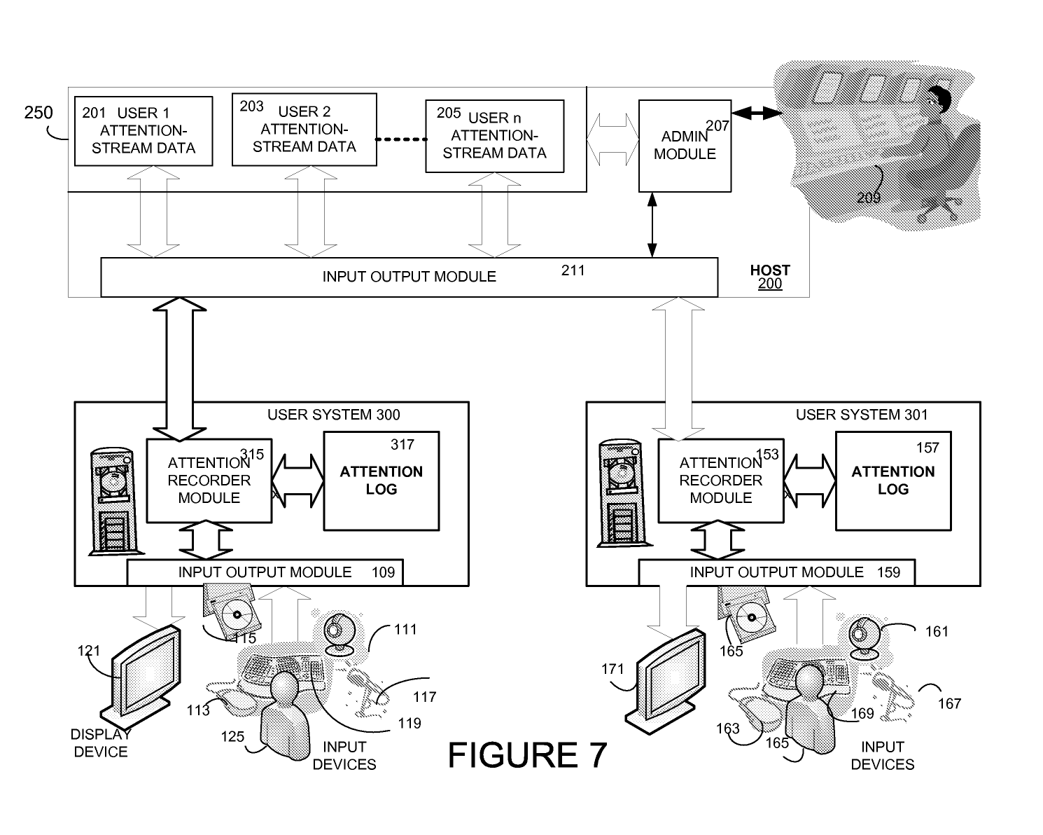

### FIG. 7 Attention Sharing System

Attention-stream sharing system 200 is configured to enable users to store their individual attention-stream information in a personal vault. FIG. 7 is a block diagram of an attention sharing system 200 according to an embodiment of the invention. In the configuration illustrated in FIG. 7 host system 200 is configured as an attention-data storage and sharing system. Host system 200 comprises a plurality of attention vaults, for example vaults 201, 203 and 205. Each vault stores an individual computer user's attention-stream. It will be understood while only three example vaults are illustrated in FIG. 7 the invention is not limited with respect to the number of vaults provided by host system 200.

According to one embodiment of the invention a vault is exclusively associated with a corresponding individual user and is managed by the corresponding user on his own behalf. System 200 enables each user to manage his or her vault and to control access to that user's vault. An administration module 207 implements functions that enable a user to manage the user's vault and the information stored in it. Administration module 207 coordinates storing, retrieving, sharing, analyzing and other processing of data stored in vaults of system 200.

System 200 further comprises an input/output unit 211 which receives attention streams from recorders in user computer systems, for example, systems 300 and 301. Input output unit 211 provides stored attention data to computer systems of requesting users. In one embodiment of the invention administration module 207 associates access permissions with each user's vault in accordance with a user's instructions. In that case stored attention data is provided only to those requesting users who have been granted access by a vault's owner.

In one embodiment of the invention host system 200 further comprises an attention recording module (not shown) similar to the attention recording modules 315 and 153 provided to user computer systems 300 and 301. The host recording module is operable to record attention-streams of host site members in accordance with an embodiment of the invention.

### Transmitting to a Vault

Computer systems 300 and 301 each comprise a corresponding attention recorder module 315 and 153. To provide attention information recorded by a recording module in an attention log to a vault, a recorder makes an HTTP request to transmit & store attention log information to system 200. In one embodiment the transmitted attention information includes a cookie associating the information with a corresponding computer system. For example recorder 315 sends an attention-stream file message record in XML format to system 200 by means of a request formatted generally in accordance with the following:

<attention

xmlns=“http://attentiontrust.org/attention/ns#”
version=“0.11” recorderGUID=“{7118cc65-ee56-4af0-b5fc-
37205e1bc61e}” recorderVersion=“0.13”>

<httpTransactions>
<httpTransaction>
<title>Home | AttentionTrust.org</title>

<url>http://www.google.com/search?q=attention</url>

<cookie>1</cookie>
<setCookie>0</setCookie>
<responseCode>200</responseCode>
<method>GET</method>
<date>Tue, 04 Oct2005 15:07:16 GMT</date>

</httpTransaction>

</httpTransactions>

</attention>--

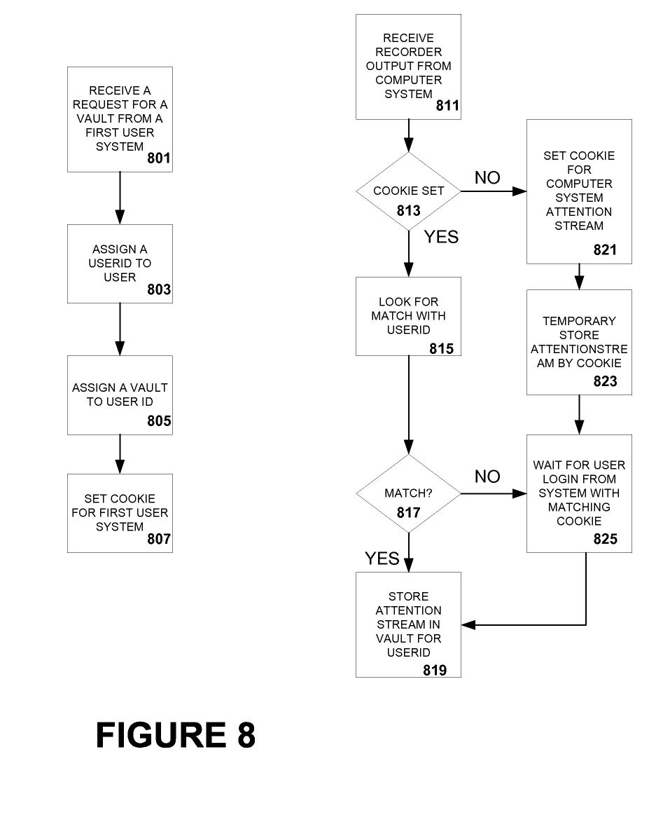

### FIG. 8 Storing

System 200 further enables a user to share the attention-stream information in the user's vault with other users or service provider systems. Each individual user's attention recorder is configured to allow identification of the recorder's output with a user-member of a sharing system 200.

In one embodiment of the invention system 200 employs cookies to associate an individual's recorder with a user ID assigned to that individual. For example, an XML HTTP Request received by system 200 from an individual attention recorder allows cookies to be read and written. Thus system 200 sets a cookie upon first receiving click-stream data from a recorder. This cookie will be returned with all subsequent POST's from that attention-stream recorder. System 200 associates an individual user with the individual user's attention recorder output by examining the user's recorder output cookie when the user logs into system 200. In that manner an individual user ID is associated with a recorder belonging to that individual. In that manner a recorder's log file can be associated with an individual user-member in order to manage sharing among individual users of their individual attention-streams.

FIG. 8 illustrates steps of a method for storing, managing and sharing attention-streams. At step 801, system 200 receives a request for a personal vault from a user via a user computer system 300. At step 803, system 200 assigns a unique user ID to the requesting user. At step 805 a vault is uniquely associated with the user id. In one embodiment of the invention system 200 sets a cookie for the user's computer system and associates the cookie with the user's assigned user ID.

At step 811, system 200 receives an attention-stream from a recorder of a user computer system. At step 813 system 200 checks whether there is a cookie set for the attention-stream. If a cookie is set for the attention-stream, system 200 looks for a match between the cookie and a user ID at step 817. If system 200 determines a match exists between the cookie and a user ID, the attention-stream is stored in the vault associated with that user ID at step 819.

If no cookie is detected for a received attention-stream, system 200 sets a cookie for that attention-stream at step 821. In one embodiment of the invention the attention-stream is temporarily stored in a memory and is locatable by its assigned cookie. At step 823 system 200 waits for a user to login from a computer system having a cookie matching the cookie of the temporarily stored attention stream. In one embodiment of the invention system 200 waits for a login from a user having a matching cookie assigned to the user's ID. At step 819 when a matching cookie is identified from a user login, the temporarily stored attention-stream is then stored in the vault associated with the user having the matching cookie.

In one embodiment of the invention system 200 is configured to enable a single user to be associated with more than one recorder output. For example, suppose system 200 comprises a plurality of users, and Joe's user id is 25. Joe has installed an attention recorder in a first computer system, for example, system 300 at Joe's home. In that case, the recorder output from system 300 is associated with a cookie, for example cookie Z. Joe has installed a second attention recorder in a second computer system, for example system 301 at work. The recorder output from the recorder in system 301 is given cookie Y when received by system 200. System 200 assigns the X and Y cookies to Joe's first and second recorder outputs respectively and associates both X and Y with Joe's user ID 25.

Whenever system 200 receives a recorder output from the recorder in system 300 the recorder sends cookie Y with the recorder output. In the event Joe logs into system 200 from user system 300, the same cookie Y will be sent. When a domain sets a cookie, the set cookie is returned for all subsequent requests to that domain. Thus, system 200 associates received recorder outputs with cookie Y to user Joe with user ID 25. When Joe logs into system 200 from second user computer system 301, cookie Z will be received by system 200. Thus system 200 associates attention streams from recorders in system 301 with cookie Z with Joe and his user ID 25. Thus, system 200 associates attention-streams received from recorders in both the first and second user computer systems 300 and 301 with Joe's user ID.

In some embodiments of the invention system 200 provides a single user with more than one user ID, for example in response to a request by a user for more than one vault. In one embodiment of the invention the attention stream information for each vault is normalized into multiple relational tables. For example in one embodiment of the invention vault 201 includes normalized click-stream, domain and search tables for the individual user associated with vault 201.

### Sharing

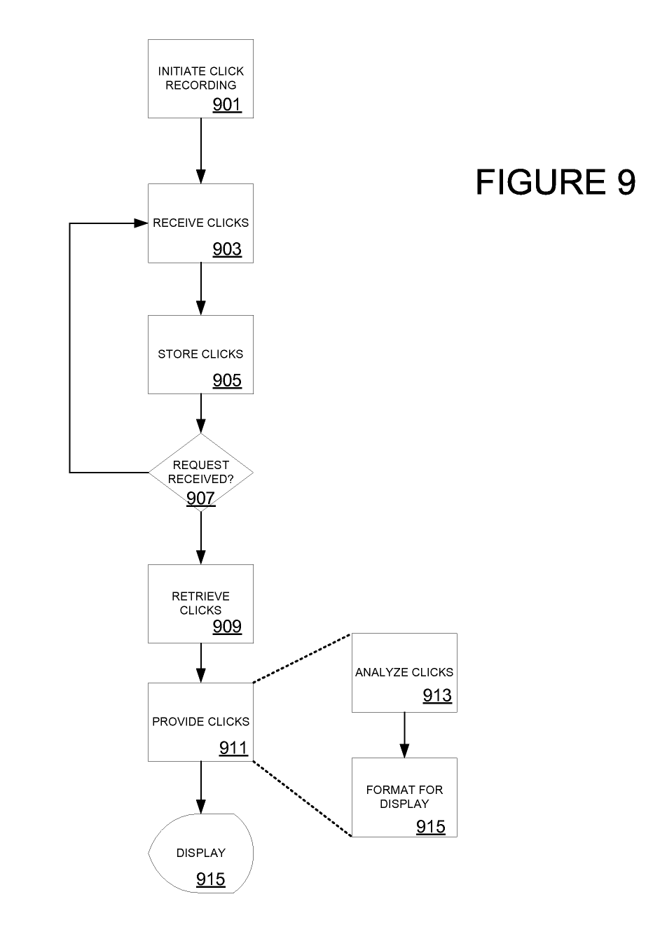

FIG. 9 illustrates steps of a method for sharing attention data. At step 901, recording of attention data by recorder 315 associated with a first computer system 300 is initiated. At steps 903 and 904, attention indications of user 125 of first computer system 300, for example clicks initiated by user 125, are detected by recorder system 100 and associated information is stored in attention log 315. In one embodiment of the invention the attention data stored in log 317 is periodically provided to a vault 201 assigned by host system 200 to user 125 as indicated at step 906. At step 907 a request for access to the attention information stored in vault 210 of first user 125 is received from a second user 165.

At step 909 host system 200 checks permissions associated with vault 210. If access permission is determined for second user 165 host system 200 provides click information stored in vault 210 to second user 165. In some embodiments of the invention the clicks are provided for display by second user 165 on display device 171 of second user system 301.

Host system 200 provides a set of tools comprising methods and systems for carrying out data analysis, for converting physical or low level data reflecting the behavior of an individual user in a networked computer environment into a high level or logical view of the individual user's behavior that is controllable by the individual user. Therefore, in one embodiment of the invention the step 911 of providing click information is carried out by steps including step 913 of analyzing the click information stored in vault 201. At step 915 the analysis is used to format the click information for display to second user 165.

According to embodiments of the invention, first user 125 and second user 165 comprise the same user, and first and second user systems 300 and 301 comprise the same user system. Accordingly, a user can request and receive analyzed and formatted information from the user's own vault.

With reference to FIG. 10, there is shown a graphical user interface whereby a user can both display their own click-stream data (see the Search button and data entry field) and exchange their click-stream data with another user to implement a vault exchange function of system 200. In different embodiments of the invention, the user may authorize other users (private and/or commercial) to access his click-stream data, receive permission to access another user's click-stream data, and/or exchange rights to access click-stream data with others.

In some embodiments the rights received or granted may be limited and/or conditional, for example granting access to limited click-stream data and/or granting rights only in the event a user meets a specified condition. This ability to share and exchange click-stream data, both with commercial and non-commercial users, provides significant benefits and advantages to the users. Non-commercial users may benefit in many ways from considering the attention of others, that is the click-streams of others, in all manners from satisfying curiosity to sharing research to learning, and others as will now be apparent to the reader. Commercial users may learn significant information leading to new customer acquisition, improved customer service, product and service sales and other benefits as will now be apparent to the reader.

### Vaults 250

Host computer 200 comprises a plurality of vaults, e.g., 201, 203, 205. Each vault comprises a log file generated by an individual attention recorder associated with an individual user of a user computer system 300. Host system 200 is configured to enable a user to store the user's attention information, for example, the user's click information in a corresponding vault. In some embodiments of the invention a vault is usable to store a user's attention-stream, user activity, histories of web page visits, history of searches and the like. When a user selects an attention service comprising a vault service (illustrated in FIG. 3 at 353) host system 200 allocates a vault to user 125.

In one embodiment of the invention each vault of system 200 comprises a log file corresponding to a user. For example, vault 201 corresponds to user 125. In that case vault 201 stores attention information, for example, clicks generated by user 125. In a like manner, vaults 203 and 205 store clicks corresponding to other users.

### Attention Sharing Systems

Host system 200 is configured to enable users 125 and 165 to record user selected information related to their respective browsing histories and click-stream generation in respective corresponding vaults 201 and 203. In addition to storing the user selected information in attention logs 317, 157 locally as a .txt file, attention recorder modules 315 and 153 communicate with host system 200 to enable each user 125 and 165 to share his or her data with the other user. In one embodiment of the invention, host system 200 implements an attention sharing service. In one embodiment of the invention, users 125 and 165 are enabled to designate other users, services and other requestors, to access information stored in the user's corresponding vaults 201 and 203.

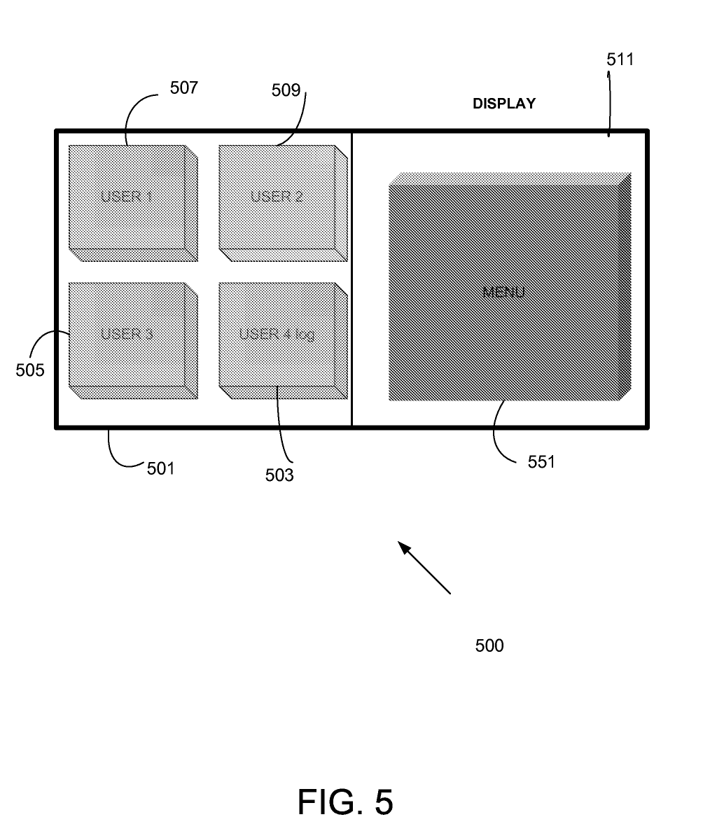

FIG. 5 illustrates a graphical user interface 500 for displaying attention information of more than one user according to an embodiment of the invention. In the example of FIG. 5 attention information for four users, for example, users 125, 165 and two others (not shown) is displayed in screen portions 503, 505, 507 and 509 respectively. A menu of options enabling a user, e.g., user 125 to select, share and display attention information is displayed in screen portion 551.

### Administration Module

Administration module 207 cooperates with browser plug in 315 to enable users to control the collection and dissemination of the information in the user's vault. Administration module 207 is configured to enable permissioning, i.e. the granting of access authorization or permission, to an enumerated list of people and/or groups or through publication or other methods. Administration module 207 cooperates with a user's recorder to enable the users to select approved services to receive click-streams from the user's recorder. In one embodiment of the invention a list of approved services is pulled from an RSS feed, for example, an RSS feed identified in accordance with the following general format:

http://attentiontrust.org/rss/services

In one embodiment of the invention a toolkit is provided to enable users 125 to query and analyze click information. In one embodiment of the invention the toolkit cooperates with a user system to enable the user to provide services to other users in a manner similar to the operation of web host system 200.

According to one embodiment of the invention the toolkit is implemented as an open-source utility that records “attention data” from the attention portions of vault 250 into a database, for example, a MySQL database. To develop a service that can accept data provided by an attention recorder, the recorder is configured by the user to send the user's click-stream to a URL on a server of a service provider. The service provider creates a URL for its service which can accept the XML data sent by the user's attention recorder. A user can have a click-stream sent to non-approved services by manually modifying the users preferences, for example by modifying the contents of a preference file.

There have thus been provided new and improved methods and systems for enabling users to capture, store, analyze and share/distribute in a controlled manner attention data, particularly Internet website click-stream data. Captured, stored attention data may be used by the individual, or, through permissions, the data may be made available to other private and commercial users. The invention thus enables users to recognize both personal and potential commercial value from an electronic record of their attention. The invention includes not only the basic capture and store of attention data, but also the ability to process attention data in a variety of different manners. The invention has application in the field of Internet commerce and more broadly in the field of commerce generally.

While the invention has been shown and described with respect to particular embodiments, it is not thus limited. Numerous modifications, changes and enhancements will now be apparent to the reader.

What is claimed is:

1. A click recorder comprising:
a first input for receiving click indications generated by a computer user;
a click log for storing said click indications;
a second input for receiving a request for the stored click indications from at least one requestor;
a processor controlling said click log in response to said request to provide said stored click indications for display to said requestor.

2. The click recorder of claim 1 wherein said computer user comprises said requestor.

3. The click recorder of claim 2 further comprising:
a communications port configured for communication with a host computer via a web browser;
said host computer providing an interactive web page for display to said computer user, said web page including a control enabling said user to download a click control program from said host computer;
a memory for receiving and storing said click control program from said host computer user;
said processor controlling said click log in accordance with said click control program.

4. The click recorder of claim 3 further including a graphical user interface for providing a plurality of user-selectable views of said click indications for display to said user.

5. The click recorder of claim 1 comprising a host computer configured for communication with a plurality of said users, and further comprising:
a subscriber module for enabling a user to subscribe for services provided by said host computer, said user comprising a subscriber;
a subscriber database configured to store subscriber information.

6. The click recorder of claim 5 further comprising:
a click-stream identification module configured to associate subscriber information stored in said database with said click indications stored in said memory;
said database configured to receive and store click-stream access indicators from said subscribers;
a click-stream management module coupled between said second input and said first output to evaluate said request and to provide said click indicators based upon said click access indicators.

7. A method for processing click information comprising:
receiving click indications generated by a click generating subscriber;
storing said received click indications;
receiving a request for said stored click indications from at least one requesting subscriber;
providing said click indications to said at least one requesting subscriber in response to said request.

8. The method of claim 1 further comprising steps of:
downloading instructions comprising a browser plug-in;
operating said processor in accordance with said instructions to receive and store said click-indications;
providing information about said click indications to a display unit of said personal computer thereby enabling said click generating subscriber to view said click indications.

9. The click recorder of claim 3 further including steps of:
providing a plurality of user-selectable views of said click indications;
enabling said click indication generating subscriber to select at least one of said view for display on said display unit;
displaying said selected view on said display unit.

10. An attention-stream recorder comprising:
a browser plug in module configured to detect signals indicating attention of a computer user, the plug in module including:
an analyzer for receiving detected signals and providing data representing user attention based on the detected signals;
a converter coupled to the analyzer and providing formatted data representing user attention;
an attention log coupled to the converter output for receiving and storing the formatted data.

11. The attention-stream recorder of claim 1 wherein the signals indicating attention comprise clicks and the formatted data comprises click-streams.
